(19) United States
(12) Patent Application Publication
(10) Pub. No.: US 2025/0304439 A1
(43) Pub. Date: Oct. 2, 2025

(54) HYDROGEN GENERATION APPARATUS

(71) Applicant: CANON KABUSHIKI KAISHA, Tokyo (JP)

(72) Inventors: AKIKO TOMINAGA, Kanagawa (JP); SHOKO FUJIWARA, Ibaraki (JP); KEIJI KARUBE, Ibaraki (JP); TSUYOSHI KUROKI, Kanagawa (JP); SHUNSUKE TSUDA, Tokyo (JP); KENJI UTSUNOMIYA, Tokyo (JP)

(21) Appl. No.: 19/240,748

(22) Filed: Jun. 17, 2025

Related U.S. Application Data
(63) Continuation of application No. PCT/JP2023/044543, filed on Dec. 13, 2023.

(30) Foreign Application Priority Data
Dec. 20, 2022 (JP) 2022-203052

(51) Int. Cl. C01B 3/06

(52) U.S. Cl. CPC C01B 3/065; C01B 2203/0805; C01B 2203/1205; C01B 2203/1614; C01B 2203/169

(57) ABSTRACT

A hydrogen generation apparatus includes a first liquid providing apparatus and a controller. The first liquid providing apparatus provides a liquid containing at least water to a solid hydrogen carrier. The controller controls an amount of the liquid that the first liquid providing apparatus provides to the hydrogen carrier.

### CROSS-REFERENCE TO RELATED APPLICATIONS

This application is a Continuation of International Patent Application No. PCT/JP2023/044543, filed Dec. 13, 2023, which claims the benefit of Japanese Patent Application No. 2022-203052, filed Dec. 20, 2022, both of which are hereby incorporated by reference herein in their entirety.

### BACKGROUND

### Field of the Technology

The present disclosure relates to a hydrogen generation apparatus that generates hydrogen by using, as a raw material, a hydrogen carrier having a nature of generating hydrogen when a water-containing liquid is poured thereon.

### Description of the Related Art

As a hydrogen generation apparatus, an apparatus that supplies water and a solvent to sodium borohydride and generates hydrogen by hydrolysis of the sodium borohydride is proposed (for example, Patent Literature 1).

### CITATION LIST

### Patent Literature

Patent Literature 1: Japanese Patent Application Laid-Open No. 2017-114708

Patent Literature 1 described above does not describe a specific configuration indicating how water and solvent are supplied to sodium borohydride. As a hydrogen generation apparatus, it is desired that a hydrolysis reaction with a hydrogen carrier such as sodium borohydride is stably progressed.

### SUMMARY

The present disclosure provides a hydrogen generation apparatus that easily promotes a reaction between a hydrogen carrier and a water-containing liquid.

According to a first aspect of the present disclosure, a hydrogen generation apparatus includes a first liquid providing apparatus configured to provide a liquid containing at least water to a solid hydrogen carrier; and a controller configured to control an amount of the liquid that the first liquid providing apparatus provides to the hydrogen carrier. The first liquid providing apparatus ejects the liquid in a form of droplets of 100 pl or less.

According to a second aspect of the present disclosure, a hydrogen generation apparatus includes a liquid providing apparatus configured to provide a liquid containing water to a solid hydrogen carrier; and a hydrogen collection apparatus configured to collect hydrogen generated by a reaction between the hydrogen carrier and the liquid, wherein the liquid providing apparatus provides the liquid toward the hydrogen carrier in a form of droplets.

Features of the present disclosure will become apparent from the following description of embodiments with reference to the attached drawings.

### BRIEF DESCRIPTION OF THE DRAWINGS

FIG. 1 is a schematic configurational section view of a hydrogen generation apparatus according to a first embodiment.

FIG. 2 is a control block diagram of the hydrogen generation apparatus according to the first embodiment.

FIG. 3A is a schematic configurational section view of an ink jet head of a thermal type.

FIG. 3B is a schematic configurational section view of an ink jet head of a piezo type.

FIG. 4 is a schematic configurational section view of a line ink jet head.

FIG. 5 is a schematic configurational section view of a serial ink jet head.

FIG. 6 is a schematic configurational section view of a hydrogen generation apparatus according to a second embodiment.

FIG. 7 is a schematic configurational section view of a hydrogen generation apparatus according to a third embodiment.

### DESCRIPTION OF THE EMBODIMENTS

### First Embodiment

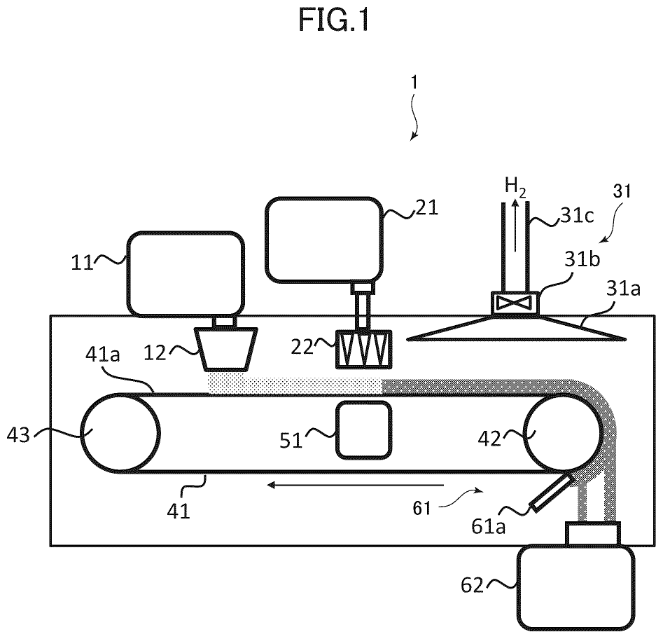

A first embodiment will be described with reference to FIGS. 1 to 5. First, hydrogen is attracting attention as an energy source to replace fossil fuel. This is because, unlike fossil fuel, when being combusted, hydrogen does not generate, for example, carbon dioxide that is a kind of a greenhouse gas that causes global warming. One example of a system that uses hydrogen as an energy source and that is put into practical use is a fuel cell vehicle. A fuel cell vehicle is an automobile that generates power by using hydrogen as a raw material and moves by driving an electric motor by the generated power. Most of fuel cell vehicles store hydrogen serving as an energy source in a hydrogen tank, and generates power by charging the hydrogen discharged from the hydrogen tank into a fuel cell. In the hydrogen tank, hydrogen is stored in a compressed state at a high pressure such as 70 MPa (700 times as high as atmospheric pressure).

Hydrogen serving as an energy source has a problem that the energy density thereof is low. The volume energy density of hydrogen is about 1/3000 of that of gasoline, and energy of only about ⅕ of that of gasoline of the same volume can be obtained even if the hydrogen tank of 70 MPa is used. Therefore, typically, a fuel cell vehicle including a hydrogen tank is required to be charged with energy more frequently than an automobile using gasoline.

Therefore, as a material (that is, a hydrogen carrier) that can carry hydrogen at a higher energy density than a hydrogen tank, various materials are considered. For example, ammonia, methylcyclohexane, and the like are known as hydrogen carriers, and transporting a hydrogen carrier instead of hydrogen itself and taking out hydrogen from the hydrogen carrier at use are performed.

Among hydrogen carrier materials like these, metal hydrides such as sodium borohydride from which hydrogen can be easily taken out by pouring water thereon are widely known. As a method of obtaining hydrogen by hydrolysis of sodium borohydride, a method of dissolving sodium borohydride in water and using it as an aqueous solution is known. However, in the case of this method, there is a problem that more water than an amount required in the theory represented by the reaction formula is required, and thus the substantial volume energy density is reduced.

Therefore, in the present embodiment, hydrogen is generated by pouring a water-containing liquid on a solid hydrogen carrier by a hydrogen generation apparatus configured as described below. In addition, a byproduct generated by the reaction between the hydrogen carrier and the liquid is collected. The byproduct can be restored into the hydrogen carrier.

### [Hydrogen Generation Apparatus]

A schematic configuration of a hydrogen generation apparatus 1 will be described by using FIG. 1. The hydrogen generation apparatus 1 of the present embodiment is an apparatus that places a hydrogen carrier that is solid (powder in the present embodiment) on the conveyance belt 41 (on a conveyance member), ejects a water-containing liquid thereonto, reacts the hydrogen carrier with the water-containing liquid on the conveyance belt 41, and thus generates hydrogen. The hydrogen generation apparatus 1 mainly includes the conveyance belt 41, a powder application apparatus 12 serving as an application apparatus, a liquid ejection apparatus 22 serving as an ejection apparatus, a hydrogen collection apparatus 31, and a byproduct collection apparatus 61.

The conveyance belt 41 rotates in an arrow direction of FIG. 1. The powder application apparatus 12 receives supply of hydrogen carrier from a hydrogen carrier storage case 11 storing a hydrogen carrier that is powder, and applies the hydrogen carrier on a surface 41a of the conveyance belt 41. The liquid ejection apparatus 22 is disposed downstream of the powder application apparatus 12 in the rotational direction of the conveyance belt 41, receives supply of the liquid from a liquid storage case 21 storing the water-containing liquid, and ejects the liquid onto the hydrogen carrier applied on the surface 41a of the conveyance belt 41.

The hydrogen collection apparatus 31 is disposed downstream of the liquid ejection apparatus 22 in the rotational direction of the conveyance belt 41, and collects hydrogen generated by the reaction between the hydrogen carrier and the liquid on the surface 41a of the conveyance belt 41. The byproduct collection apparatus 61 collects the byproduct generated by the reaction between the hydrogen carrier and the liquid on the surface 41a of the conveyance belt 41. The byproduct mentioned herein refers to a product other than hydrogen generated by the reaction between the hydrogen carrier and the liquid. In addition, the hydrogen generation apparatus 1 of the present embodiment further includes a heating apparatus 51 that heats the conveyance belt 41. To be noted, the heating apparatus 51 may be omitted.

The hydrogen generation apparatus 1 can perform, on the conveyance belt 41, a series of steps such as generating hydrogen by the reaction between the hydrogen carrier and the water-containing liquid, and collecting the byproduct after the reaction. Therefore, an advantage that hydrogen can be generated continuously, stably, and in a long term is realized in a compact apparatus configuration.

The operation of the hydrogen generation apparatus 1 is as follows. First, the conveyance belt 41 starts moving, and the heating apparatus 51 starts heating at the same timing. When the conveyance speed of the conveyance belt 41 has become stable at a predetermined speed and the surface temperature of the conveyance belt 41 has reached a set temperature, the powder application apparatus 12 starts operating, and applies the hydrogen carrier on the conveyance belt 41. At a timing at which the hydrogen carrier comes under the liquid ejection apparatus 22, the liquid is ejected from the liquid ejection apparatus 22, the reaction between the hydrogen carrier and the liquid is started, and the generated hydrogen is collected by the hydrogen collection apparatus 31. To be noted, in the case where the hydrogen generation apparatus 1 does not include the heating apparatus 51, the hydrogen carrier may be applied on the conveyance belt 41 regardless of the temperature of the conveyance belt 41.

Then, the byproduct generated after the reaction between the hydrogen carrier and the water-containing liquid is conveyed to the byproduct collection apparatus 61, and the byproduct is collected and sent to a byproduct collection case 62 by the byproduct collection apparatus 61. Next, each constituent element will be described in detail.

### Hydrogen Carrier

The “hydrogen carrier” mentioned in the present embodiment is not particularly limited as long as the hydrogen carrier is a solid hydrogen carrier that generates hydrogen when a water-containing liquid is poured thereon. For example, solid metal hydrides such as sodium borohydride, potassium borohydride, lithium borohydride, zinc borohydride, aluminum lithium hydride, aluminum sodium hydride, aluminum magnesium hydride, aluminum calcium hydride, magnesium hydride, lithium hydride, sodium hydride, and calcium hydride, and metal powder such as aluminum, zinc, calcium, and magnesium can be used solely or in combination. In addition, an additive such as a reaction accelerator or a desiccant may be contained.

As the hydrogen carrier, sodium borohydride is preferably used. This is because the proportion of hydrogen in sodium borohydride molecule is high with respect to the molecular weight of sodium borohydride, and the energy density is high. In addition, since the hydrogen generation reaction progresses at a low temperature close to room temperature, hydrogen can be obtained efficiently, fire is less likely to be caused by contact with water, and risk in safety is lower.

In addition, although the hydrogen carrier of the present embodiment is preferably a solid such as powder or granule, but solids such as sheets, pellets, and pastes are also usable. As the powder, one having a particle diameter of about 10 μm or more and 10 mm or less, and one having a particle diameter of 10 μm or more and 3 mm or less, and further one having a particle diameter of 10 μm or more and 100 μm or less are more preferable. In addition, in the case of use in the form of a sheet or a pellet, it is preferable to perform surface roughening, pore-forming treatment, or the like to increase the surface area and increase the contact area with the water-containing liquid from the viewpoint of enhancing the reactivity with the water-containing liquid.

In the present embodiment, a powder of sodium borohydride having an average particle diameter of 50 μm is used as the solid hydrogen carrier. To be noted, the average particle diameter of the solid hydrogen carrier is not limited to this. The sodium borohydride powder reacts with water to generate hydrogen. The reacted sodium borohydride turns into a powder of sodium metaborate that is a byproduct. This reaction is expressed as follows by a chemical formula.

NaBH₄ (sodium borohydride)+2H₂O (water)→NaBO₂ (sodium metaborate)+4H₂ (hydrogen) (1)

This reaction (chemical formula (1)) is known to be promoted by a Raney catalyst formed from metal such as nickel, cobalt, or copper, and an acidic solution such as citric acid or acetic acid.

### [Water-Containing Liquid]

The “water-containing liquid” mentioned in the present embodiment is not particularly limited as long as the liquid reacts with the hydrogen carrier and generates hydrogen when poured. That is, the water-containing liquid may be a simple of water. In addition, two or more kinds of water-containing liquids may be prepared. By preparing two or more kinds of water-containing liquids, the generation speed of hydrogen can be adjusted.

The water-containing liquid can include a water-soluble organic solvent. Examples thereof can include alcohols, polyalkylene glycols, glycol ethers, nitrogen-containing compounds, and sulfur-containing compounds. Two kinds or more selected from these can be also used in mixture. By containing a water-soluble organic solvent, adjustment of the surface tension, adjustment of the boiling point and melting point of the water-containing liquid can be performed to optimize the reaction with the hydrogen carrier.

A surfactant can be added to the water-containing liquid. By using the surfactant, the surface tension of the water-containing liquid can be reduced, the contact area with the hydrogen carrier can be increased, and thus efficient reaction can be performed.

The water-containing liquid can contain a water-soluble acidic substance. The acidic substance functions as a positive catalyst in the reaction between the water-containing liquid and the hydrogen carrier. By adjusting the amount of the liquid containing the acidic substance, the generation speed of hydrogen can be adjusted. Particularly, by setting the pH obtained by the water-containing liquid and the hydrogen carrier to be lower than 9.0, the hydrogen generation speed can be increased. Examples thereof include various acids such as chloric acid, sulfuric acid, nitric acid, boric acid, and organic acids, but are not limited to these.

The water-containing liquid can include a water-soluble basic substance. The basic substance functions as a negative catalyst in the reaction between the water-containing liquid and the hydrogen carrier. By adjusting the amount of the liquid containing the basic substance, the generation speed of hydrogen can be adjusted. Particularly, by setting the pH obtained by the water-containing liquid and the hydrogen carrier to be equal to or higher than 9.0, the hydrogen generation speed can be reduced. Examples thereof include bases such as sodium hydrate, potassium hydrate, and ammonia water, but are not limited to these.

The water-containing liquid can include a buffer liquid. The buffer liquid functions to suppress pH fluctuation in the reaction between the water-containing liquid and the hydrogen carrier. By adjusting the amount of the liquid containing the buffer liquid, the generation speed of hydrogen can be adjusted. Examples thereof include various buffer liquids such as a phosphoric acid buffer liquid, a glycine buffer liquid, a Good's buffer liquid, a Tris buffer liquid, and an ammonia buffer liquid, but are not limited to these.

The water-containing liquid may contain various additives such as a defoaming agent, a pH adjuster, a viscosity adjuster, a rust inhibitor, an antiseptic agent, an antifungal agent, an antioxidant, and an anti-reduction agent in addition to the components described above if necessary.

### [Catalyst]

As a catalyst material that can be used in mixture with the hydrogen carrier, platinum group such as platinum Pt, ruthenium Ru, rhodium Rh, palladium Pd, osmium Os, or iridium Ir, Raney catalysts formed from metals such as cobalt Co, nickel Ni, and copper Cu, fluorinated hydrogen absorbing alloys, and the like can be employed. The catalyst is preferably formed such that the surface area thereof is large. For example, a structure in which the catalyst material is borne on a porous material such as y alumina or a alumina, carbon powder, or the like may be employed. The generation speed of hydrogen can be adjusted by increasing the contact area between the hydrogen carrier and the catalyst material.

### [Desiccant]

The hydrogen carrier reacts with the water-containing liquid to generate hydrogen. Therefore, a small amount of hydrogen can be generated by reacting also with water in the external environment such as the moisture in the air. This causes decrease in the energy density. In addition, there is a risk for safety caused by unexpected generation of hydrogen, such as deformation and breakage of the apparatus caused by increase in the internal pressure of the hydrogen carrier storage case 11 and fire caused by leakage of hydrogen to the outside.

Desiccant can be used to prevent this. The desiccant may be mixed with the hydrogen carrier. A bag containing desiccant and transmitting air and water vapor may be sealed into the hydrogen carrier storage case 11. In addition, the bag containing desiccant may be attached to the hydrogen carrier storage case 11 so as not to mix with the hydrogen carrier. As the desiccant, calcium oxide (quicklime), calcium chloride, silica gel, molecular sieve, polyacrylic acid, silica alumina gel, and the like can be mentioned, but the desiccant is not limited to the exemplified substances as long as the desiccant contributes to drying.

### [Temperature of Water-Containing Liquid]

The temperature of the water-containing liquid is preferably higher than 0° C. and equal to or lower than 80° C. In the case of 0° C. or lower, the water-containing liquid is partially frozen, thus the concentration of a component of the water-containing liquid changes, and there is a possibility that an intended hydrogen generation amount cannot be obtained. In contrast, in the case of a temperature higher than 80° C., the evaporation of the water-containing liquid becomes more frequent, thus the concentration of the component of the water-containing liquid changes, and there is a possibility that an intended hydrogen generation amount cannot be obtained.

The hydrogen generation speed can be adjusted by managing the temperature of the water-containing liquid. In this case, the temperature of the water-containing liquid can be measured by a thermometer (not illustrated) of a contact type or a contactless type installed on the inside or the outside of the liquid storage case 21 or the liquid ejection apparatus 22. In addition, the temperature of the water-containing liquid can be adjusted by using a temperature adjusting apparatus (heating apparatus, cooling apparatus (not illustrated)) on the inside or the outside of the liquid storage case 21 or the liquid ejection apparatus 22. In addition, the temperature may be adjusted by natural heat dissipation or the like.

[Amount of Water-Containing Liquid with Respect to Hydrogen Carrier]

The hydrogen generation apparatus 1 of the present embodiment controls the amount of providing of the water-containing liquid to the hydrogen carrier as will be described in detail later. The control of the providing amount is performed by a central control apparatus (described later). The central control apparatus controls the providing amount on the basis of a program stored in advance by receiving a signal obtained from hydrogen application of a fuel cell or the like supplied by the hydrogen generation apparatus 1, each apparatus of the hydrogen generation apparatus 1, and the like.

For example, in the case of using sodium borohydride as the hydrogen carrier, hydrogen is generated by a reaction with the water-containing liquid. The reacted sodium borohydride turns into sodium metaborate. The chemical formula of this reaction is as expressed by the chemical formula (1) described above.

According to the chemical formula (1), it is best to perform control such that the water-containing liquid containing 2 mol equivalent of water is provided to 1 mol equivalent of sodium borohydride. This is because the energy density becomes the highest. However, in the case of increasing the reaction rate of sodium borohydride at, for example, the start of the hydrogen generation reaction, there is a case where the water-containing liquid containing 2 mol equivalent or more of water is provided because the reaction progresses more in the case of more water.

Since it is also known that sodium metaborate exists in the form of hydrate, in the case where the water-containing liquid containing 2 mol equivalent or more of water is provided, sodium metaborate remains after the reaction in the form of hydrate. Since sodium metaborate exists in the form of tetrahydrate maximum, sodium metaborate hydrate remains after the reaction in the case where the water-containing liquid containing 6 mol equivalent or less of water is provided. In the case where the water-containing liquid containing 6 mol equivalent of water is provided, the water is excessive, and sodium metaborate tetrahydrate and water remain after the reaction. To avoid excessive decrease in the energy density and consider reduction of product collection amount after the reaction, it is preferable to provide the water-containing liquid containing 2 mol equivalent or more and 6 mol equivalent or less of water.

### [Conveyance Belt]

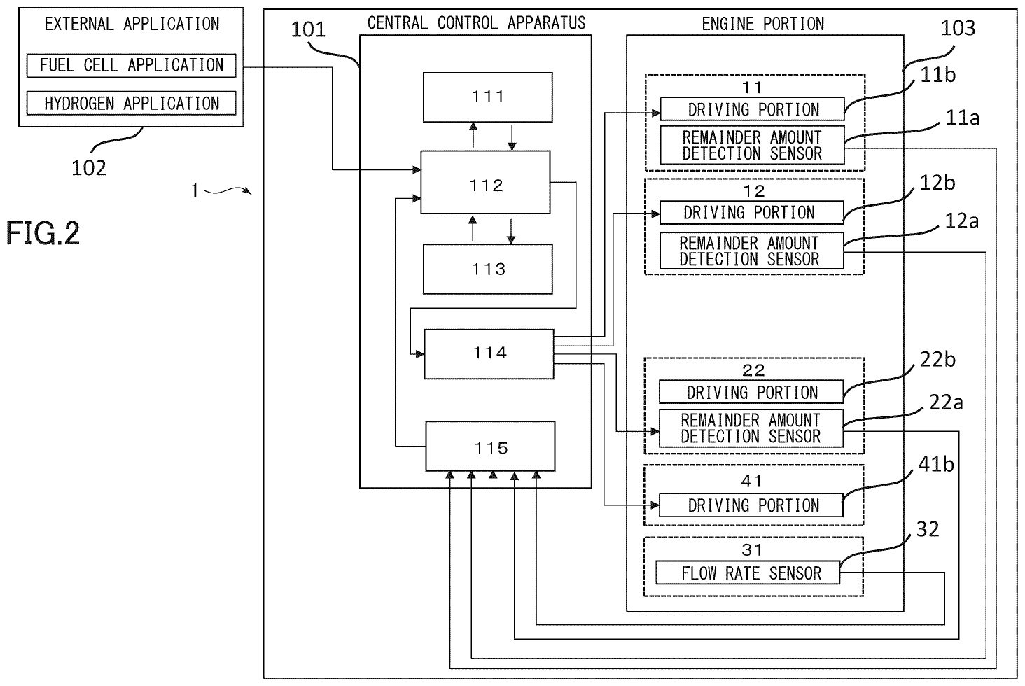

The conveyance belt 41 serving as a conveyance member is an endless belt, and is capable of conveying the solid hydrogen carrier. The conveyance belt 41 is stretched by the driving roller 42 and the driven roller 43. The driving roller 42 is fixed, the driven roller 43 is subjected to a force pushing out the driven roller 43 to the front surface side of the conveyance belt by the urging force of an unillustrated urging spring, and a certain tension is applied to the conveyance belt 41 due to this force. In addition, the driving roller 42 is coupled to a driving portion 41b (see FIG. 2) such as a motor, and thus the conveyance belt 41 circulates (i.e. rotates) in a clockwise direction (arrow direction) of FIG. 1 as a result of the driving roller 42 being rotationally driven by the driving portion 41b. Although the conveyance belt 41 is supported by two rollers in the present embodiment, there is no problem if, for example, the conveyance belt 41 is supported by a plurality of rollers such as three rollers.

In either case, the conveyance belt 41 is provided such that a stretched surface stretched by two rollers (the driving roller 42 and the driven roller 43 in the present embodiment), that is, the surface 41a described above is oriented in approximately the horizontal direction. In addition, the surface 41a is a surface facing up, and the powder application apparatus 12, the liquid ejection apparatus 22, and the hydrogen collection apparatus 31 disposed above the conveyance belt 41 oppose the surface 41a.

The conveyance belt 41 configured in this manner includes a mechanism that functions to convey the hydrogen carrier applied on the conveyance belt 41 by the powder application apparatus 12 toward the downstream side in the rotational direction in the order of the liquid ejection apparatus 22 and the hydrogen collection apparatus 31. After this, the byproduct after the reaction is conveyed further downstream to the byproduct collection apparatus 61. In addition, the heating apparatus 51 that heats the conveyance belt 41 from the inner peripheral surface side is provided on the inner side of the conveyance belt 41.

The conveyance belt 41 is preferably imparted with electrical conductivity from the viewpoint of not causing static electricity, and may be formed from metal or resin. In the case of metal, aluminum, iron, copper, Ni, stainless steel (SUS), and the like can be used. In addition, in the case of resin, a resin having a high glass transition temperature is preferable from the viewpoint of heat resistance, and for example, engineering plastics having high heat resistance and high durability such as polyimide, polyamideimide, and polyether ether ketone are preferable. In addition, in the case of resin not having electrical conductivity, it is preferable that the resin contains an antistatic agent such as carbon black to have electrical conductivity imparted. In addition, it is preferable that the thickness of the conveyance belt 41 is about 30 μm or more and 200 μm or less from the viewpoint of thermal conductivity. In the present embodiment, an endless belt formed from resin imparted with electrical conductivity that is polyimide containing carbon is used as the conveyance belt 41.

The conveyance speed (rotational speed) of the conveyance belt 41 is a predetermined speed set for each kind of the hydrogen carrier and the water-containing liquid that are used. In addition, it is preferable that the conveyance speed is adjustable as appropriate in accordance with the required hydrogen amount. As a result of this, in the case where, for example, the amount of hydrogen collected by the hydrogen collection apparatus 31 has not reached a planned amount, the hydrogen generation amount can be adjusted by, for example, appropriately adjusting the conveyance speed in accordance with the hydrogen amount measured by a flow rate sensor 32 (see FIG. 2) or the like that measures the flow rate of the hydrogen collected by the hydrogen collection apparatus 31.

### [Powder Application Apparatus]

The powder application apparatus 12 is an apparatus that receives supply of the hydrogen carrier from the hydrogen carrier storage case 11 and applies the hydrogen carrier on the conveyance belt 41. There is no problem if the thickness of the hydrogen carrier applied on the conveyance belt 41 is about 50 μm or more and 3 mm or less, but it is preferable that the thickness is set to 50 μm or more and 500 μm or less to improve the reactivity with the water-containing liquid.

In addition, the hydrogen carrier storage case 11 serving as a hydrogen carrier replenishment container stores hydrogen carrier (hydrogen carrier for replenishment) for replenishment of the storage portion of the powder application apparatus 12. The hydrogen carrier storage case 11 is attachable to and detachable from the powder application apparatus 12. That is, the hydrogen carrier storage case 11 is replaceable.

### [Liquid Ejection Apparatus]

The liquid ejection apparatus (first liquid providing apparatus) 22 is a liquid providing apparatus that receives supply of the water-containing liquid from the liquid storage case 21 storing the water-containing liquid and provides the water-containing liquid to the hydrogen carrier on the conveyance belt 41. The liquid ejection apparatus 22 can adjust the amount of the water-containing liquid with respect to the amount of the hydrogen carrier. The liquid ejection apparatus 22 preferably ejects the liquid onto the conveyance belt 41 in a contactless manner.

The liquid ejection apparatus 22 of a contactless type has no particular problem as long as the liquid ejection apparatus 22 is one, as described later, that can provide the water-containing liquid to the hydrogen carrier in the form of droplets such as a spray system, a dispenser system, or an ink jet system. By ejecting the liquid onto the hydrogen carrier in the form of droplets, the contact area between the hydrogen carrier and the liquid can be increased, and thus the reaction speed can be increased. In addition, the water-containing liquid can be provided to a wide area in a very thin layer, and thus generation of bubbles at the time of generation of hydrogen can be suppressed.

In the liquid ejection apparatus 22 of a contactless type, the amount of the water-containing liquid can be adjusted with respect to the hydrogen carrier. For example, the providing amount can be adjusted by adjusting the diameter and number of nozzles used for providing the water-containing liquid and the pressure applied to the liquid. In the case of an apparatus including an electrical controller, the providing amount can be adjusted by opening and closing the flow path of the water-containing liquid. The providing amount can be controlled in accordance with information based on the hydrogen generation amount and in accordance with input from the outside.

A liquid providing apparatus of a contact type may be used in combination with the liquid ejection apparatus of a contactless type. As the liquid providing apparatus of a contact type, a gravure offset roller, a bar coater, a die coater, a blade coater, a knife coater, and the like can be mentioned. The liquid providing apparatus of a contact type can adjust the providing amount of the liquid by adjusting the type of the roller, the contact pressure on the belt on which the hydrogen carrier is to be placed, the contact pressure between the blade and the roller, and the like.

In addition, the liquid storage case 21 serving as a liquid replenishment container stores the water-containing liquid to be supplied to the liquid ejection apparatus 22. The liquid storage case 21 is attachable to and detachable from the liquid ejection apparatus 22. That is, the liquid storage case 21 is replaceable.

### [Hydrogen Collection Apparatus]

The hydrogen collection apparatus 31 is provided for collecting the hydrogen generated by the reaction between the hydrogen carrier and the water-containing liquid. As illustrated in FIG. 1, it may be a canopy structure in a sense of an exhaustion apparatus, or may be one in which an upper outer wall of the hydrogen generation apparatus 1 has a slope shape and a discharge port is provided at the highest position. There is no particular problem as long as the structure collects the hydrogen generated inside the hydrogen generation apparatus 1. The hydrogen collection apparatus 31 of the present embodiment is disposed above the conveyance belt 41, and includes a collection portion 31a that collects the hydrogen generated on the conveyance belt 41, and a suction fan 31b that sucks the hydrogen collected by the collection portion 31a. The hydrogen sucked by the suction fan 31b is supplied to a supply destination such as a fuel cell through a pipe 31c.

In the fuel cell serving as one of supply destinations of hydrogen, dry hydrogen is desired. However, not only hydrogen but also a water vapor or a vapor of an alkaline substance generated by the reaction can mix into the collected gas. Therefore, it is preferable that a mechanism that removes substances other than a hydrogen gas, such as a filter containing water, a filter containing silica gel, or a steam trap incorporating a cooling apparatus, is provided in the flow path for hydrogen such as the pipe 31c.

### [Byproduct Collection Apparatus]

The byproduct collection apparatus 61 serving as a solid product collection apparatus functions to remove the byproduct on the conveyance belt 41 from the conveyance belt 41 and send the byproduct (solid product) to the byproduct collection case 62. The byproduct is, for example, sodium metaborate in the case where the hydrogen carrier is sodium borohydride. The byproduct collection apparatus 61 includes a collection blade 61a that comes into contact with the conveyance belt 41, and a blade holding member (illustration omitted) that holds the collection blade 61a.

The collection blade 61a preferably abuts the outer peripheral surface of the conveyance belt 41 stretched by a roller stretching the conveyance belt 41, which is the driving roller 42 in the present embodiment. In addition, the collection blade 61a preferably abuts a surface other than the surface 41a, such as the lower surface in the vertical direction or a side surface in the horizontal direction of the conveyance belt 41. In addition, the byproduct collection case 62 is preferably disposed below the collection blade 61a in the vertical direction. As a result of this, the byproduct collected by the collection blade 61a can be dropped by the gravity and collected by the byproduct collection case 62.

The material of the collection blade 61a is not particularly limited, and examples thereof include a rubber blade formed from rubber and used for cleaning of an intermediate transfer belt in a copier or the like. This is formed from rubber such as silicone rubber or urethane rubber, is molded into a plate shape, is attached such that the corner portion thereof is in contact in a counter direction with respect to the movement direction of the conveyance belt 41, and thus removes the byproduct on the conveyance belt 41. In addition, there is no problem in using one formed from metal or glass in a spatula shape, which is a so-called scraper, as the collection blade 61a.

The blade holding member has a function to support the collection blade 61a and apply a certain pressure to the collection blade 61a by using the warpage of the blade holding member. Although the material thereof is not particularly limited, metal is preferred because pressure is to be applied.

In addition, the byproduct collection case 62 serving as a collection container is a case for collecting the byproduct collected from the conveyance belt 41 by the collection blade 61a. The byproduct collection case 62 is attachable to and detachable from the byproduct collection apparatus 61. That is, the byproduct collection case 62 is replaceable.

### [Heating Apparatus]

The heating apparatus 51 has a function to heat the conveyance belt 41 from the inner peripheral surface side to promote the reaction between the hydrogen carrier and the water-containing liquid and stably generate hydrogen. As a result of this, in the hydrolysis reaction of the hydrogen carrier, hydrogen can be stably taken out without using a reaction accelerator such as a catalyst.

In addition, a system of heating the conveyance belt 41 by the heating apparatus 51 is a system having a high energy efficiency in terms of heating as compared with a system such as one heating the hydrogen carrier or one heating the water-containing liquid because the range to be heated can be limited, and the timing of the heating can be performed only during the reaction between the hydrogen carrier and the water-containing liquid.

The heating apparatus 51 may be one that heats the conveyance belt 41 via a film or a belt, one that directly transmits the heat of the heater to the conveyance belt 41, or one that includes a heater of an induction heating system if the conveyance belt 41 is formed from metal. There is no particular limitation as long as heat is quickly transmitted to the conveyance belt 41 and the conveyance belt 41 can be heated quickly. In addition, a configuration in which a heater is provided on the outer peripheral surface side of the conveyance belt 41 and the hydrogen carrier and the water-containing liquid are directly heated has no problem either. To be noted, in the case of a configuration of heating from the outer peripheral surface side, a configuration in which heating is performed via a heating film or the like is preferable because the hydrogen in contact with the heater should be avoided from the viewpoint of safety.

### [Central Control Apparatus]

FIG. 2 is a block diagram illustrating a system of the hydrogen generation apparatus 1 of the present embodiment. A central control apparatus 101 includes a controller 112, a random access memory (RAM) 111, a storage 113 that stores a program, a communication interface, a signal transmitting portion 114, and a signal receiving portion 115. The controller 112 is constituted by a central processing unit (CPU) or a CPU and a read-only memory (ROM), and issues a control command to the whole hydrogen generation apparatus 1 by executing the program stored in the storage 113.

The RAM 111 is a main memory for work by the controller 112. The storage 113 is a storage region for storing a control program and the like, and the controller 112 performs processing by reading a control program, time-series data that is temporarily stored, log information, and the like from the RAM 111 and the storage 113.

Information from an external application 102 such as hydrogen application of the fuel cell to which the hydrogen generation apparatus 1 supplies or fuel cell application of a fuel cell vehicle (FCV) or the like that uses a fuel cell is input to the controller 112. In addition, the controller 112 receives information of an engine portion 103 of the hydrogen generation apparatus 1 through the signal receiving portion 115. As the information of the engine portion 103, a hydrogen amount detected by the flow rate sensor 32 provided in the hydrogen collection apparatus 31, information of remainder amount detection sensors 11a, 12a, and 22a provided in the hydrogen carrier storage case 11, the powder application apparatus 12, and the liquid ejection apparatus 22, and the like can be mentioned.

The remainder amount detection sensor 11a is a sensor that is provided in the hydrogen carrier storage case 11 and detects the remainder amount of the hydrogen carrier in the hydrogen carrier storage case 11. The remainder amount detection sensor 12a is a sensor that is provided in the powder application apparatus 12 and detects the remainder amount of the hydrogen carrier in the powder application apparatus 12. The remainder amount detection sensor 22a is a sensor that is provided in the liquid ejection apparatus 22, and detects the remainder amount of the water-containing liquid in the liquid ejection apparatus 22.

Further, the controller 112 transmits, as a signal generated in accordance with a control information set in advance, a replenishment signal to the hydrogen carrier storage case 11, a driving signal to the powder application apparatus 12 and the liquid ejection apparatus 22, a driving signal to the conveyance belt 41, and the like, via the signal transmitting portion 114.

The hydrogen carrier storage case 11 includes a driving portion 11b for replenishing the powder application apparatus 12 with the hydrogen carrier. The powder application apparatus 12 includes a driving portion 12b for applying the hydrogen carrier on the conveyance belt 41. The liquid ejection apparatus 22 includes a driving portion 22b for ejecting the liquid onto the hydrogen carrier on the conveyance belt 41. In addition, the conveyance belt 41 is driven by the driving portion 41b as described above. The controller 112 controls the drive of the driving portions 11b, 12b, 22b, and 41b.

Specifically, the driving portion 11b of the hydrogen carrier storage case 11 is, for example, a motor or a solenoid that drives a shutter provided at a connecting portion between the hydrogen carrier storage case 11 and the powder application apparatus 12. The controller 112 performs and stops the replenishment operation of the hydrogen carrier from the hydrogen carrier storage case 11 to the powder application apparatus 12 by, for example, driving the driving portion 11b to open and close the shutter.

The driving portion 12b of the powder application apparatus 12 is, for example, a motor that drives a roller for applying the hydrogen carrier on the conveyance belt 41. The controller 112 drives the driving portion 12b to control the drive of the roller, and thus performs and stops the application operation of the hydrogen carrier from the powder application apparatus 12 to the surface 41a of the conveyance belt 41.

The driving portion 22b of the liquid ejection apparatus 22 is, for example, one for ejecting the liquid onto the conveyance belt 41, and the driving configuration differs depending on the system thereof. The controller 112 controls the driving of the driving portion 22b, and thus performs the liquid ejection operation thereof onto the surface 41a of the conveyance belt 41 from the liquid ejection apparatus 22 and the stop thereof. In addition, the controller 112 controls the amount of the liquid that the liquid ejection apparatus 22 applies to the hydrogen carrier.

The driving portion 41b of the conveyance belt 41 is, for example, a motor as described above. The controller 112 controls the drive of the driving portion 41b, and thus drives and stops the conveyance belt 41, and further controls the driving speed thereof.

### [Detailed Configuration of Liquid Ejection Apparatus]

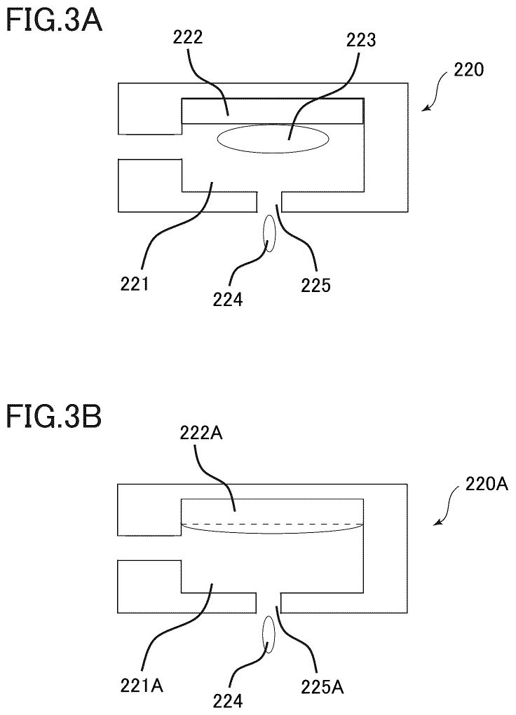

Next, a detailed configuration of the liquid ejection apparatus 22 will be described by using FIGS. 3A to 5. Here, as a method for manufacturing hydrogen, there is a case where sodium borohydride is used in the state of being dissolved in water. However, in the case of this method, water of a larger amount than the amount of water theoretically indicated by the reaction formula is required, and therefore there is a problem that the substantial volume energy density decreases. In addition, a situation in which hydrogen is generated little by little while the aqueous solution is stored cannot be avoided, and the volume energy density also decreases by this. Therefore, a hydrogen generation apparatus capable of generating hydrogen while suppressing decrease in the volume energy density is desired.

Therefore, in the present embodiment, a solid hydrogen carrier is used, and the liquid ejection apparatus 22 is configured to eject the water-containing liquid in the form of droplets as described above. Specifically, an ink jet system used for an ink jet printer or the like is used as the liquid ejection apparatus 22. To be noted, although a case where an ink jet head is used as the liquid ejection apparatus 22 will be described below, this includes ones having a similar configuration even if an ink jet head is not actually used. That is, the ink jet head described below also includes ones having a similar configuration that are not necessarily manufactured for ink jet printers.

By using an ink jet head as the liquid ejection apparatus 22, the water-containing liquid can be provided to the hydrogen carrier in the form of minute droplets. As a result of this, in the case of providing the same amount of the liquid, the contact area between the hydrogen carrier and the water-containing liquid increases as compared with other systems, thus the reaction speed can be increased, and hydrogen can be generated while suppressing the decrease in the volume energy density. In addition, by ejecting the water-containing liquid in the form of droplets, the amount of the water-containing liquid can be controlled very precisely, and thus a necessary amount of hydrogen can be generated at a necessary timing.

Further, by ejecting the water-containing liquid in the form of droplets, the water-containing liquid can be provided to a wide area as a very thin layer, and therefore generation of bubbles at the time of generation of hydrogen can be suppressed. If bubbles are generated, there is a possibility that the bubbles reach a path for collecting the hydrogen or the like to cause contamination, that is, there is a possibility that an impurity is mixed into the collected hydrogen. In addition, when the inside of the apparatus is filled with bubbles, the bubbles attach to the apparatus. When the bubbles attach to the apparatus, there is a possibility that, for example, the bubbles interrupt the application of the hydrogen carrier and the ejection of the water-containing liquid in the next step for generating hydrogen.

Two or more kinds of water-containing liquids can be incorporated in the ink jet head. To be noted, a configuration in which the water-containing liquid is supplied to the ink jet head through a tube or the like from a liquid accumulating portion (not illustrated) provided in the hydrogen generation apparatus 1 may be employed. By employing an ink jet system, the ratio and amount of providing of the two or more kinds of the liquid can be precisely controlled. As a result of this, the total composition of the water-containing liquids that are to be provided to the hydrogen carrier can be changed, and thus the generation of hydrogen can be both promoted and suppressed.

As the ink jet head, a head of a thermal type and a head of a piezo type can be both selected. In a head 220 of the thermal type, as illustrated in FIG. 3A, a heater 222 is disposed in a flow path 221 filled with the water-containing liquid, and a liquid 224 is ejected by generating an air bubble 223 by heating by the heater 222. That is, in the head 220 of the thermal type, the heater (thermoelectric conversion element) 222 is mounted on a recording element board as an ejection element that ejects the liquid. Further, the air bubble 223 is generated by heat generation by the heater 222, and thus the liquid 224 is ejected from a nozzle 225.

In a head 220A of the piezo type, as illustrated in FIG. 3B, a piezo element 222A is disposed in a flow path 221A filled with the water-containing liquid, and the liquid 224 is ejected by applying a voltage to the piezo element 222A. That is, in the head 220A of the piezo type, the piezo element (piezoelectric element) 222A is mounted on a recording element board as an ejection element that ejects the liquid, and as illustrated in an exaggerated manner with a solid line and a broken line in FIG. 3B, a pressure is generated by vibration of the piezo element 222A, and thus the liquid 224 is ejected from a nozzle 225A.

The head of each system includes the nozzle 225 or 225A that ejects the liquid in the form of droplets. Therefore, as described above, the contact area between the hydrogen carrier and the water-containing liquid can be increased to increase the reaction speed, and hydrogen can be generated while suppressing the decrease in the volume energy density. In addition, a head of a thermal type has a small actuator part, and thus the apparatus can be miniaturized. A head of a piezo type can control the size of the droplets of the water-containing liquid by controlling the displacement amount of the actuator part, and thus can change the hydrogen generation speed.

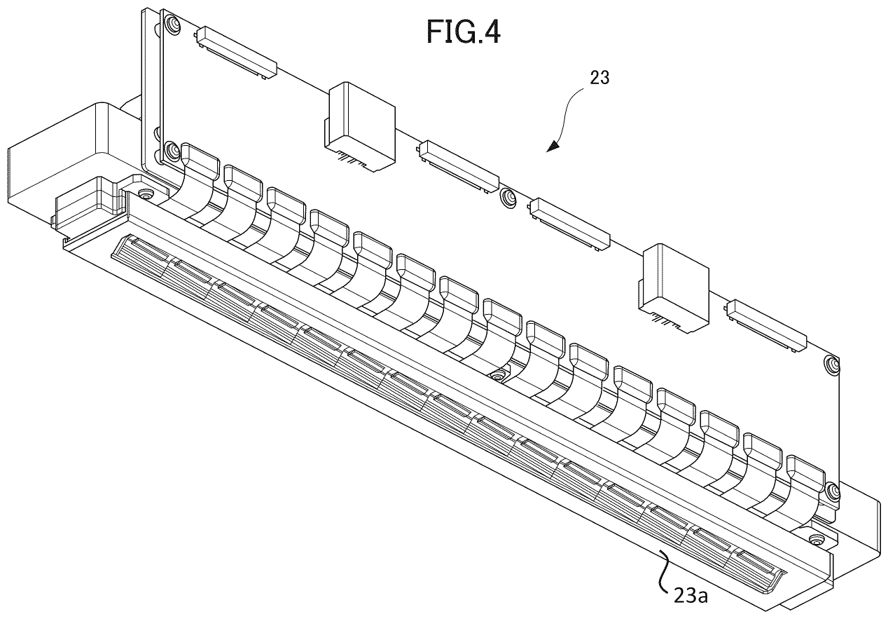

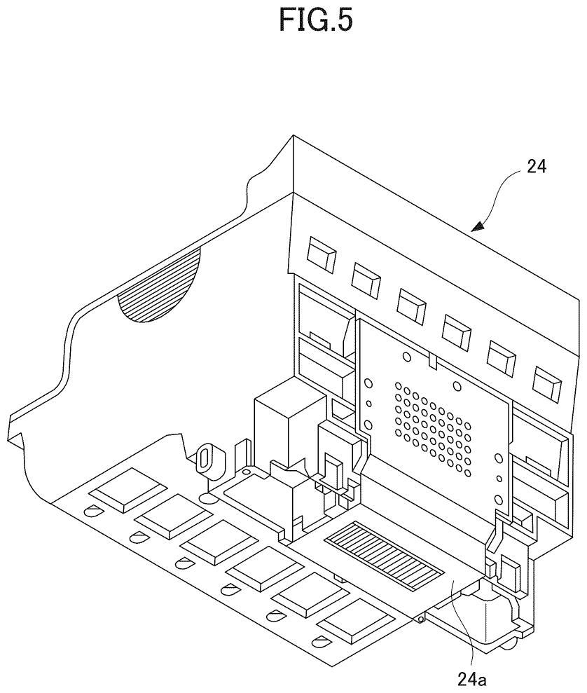

In addition, for the ink jet head, a line ink jet head 23 illustrated in FIG. 4 and a serial ink jet head 24 illustrated in FIG. 5 can be both selected. In the line ink jet head 23, a plurality of recording elements that eject the liquid are incorporated in a casing unit 23a, and the liquid is ejected onto the whole area of a target object in a width direction without movement. In the serial ink jet head 24, a casing unit 24a provided with a recording element board that ejects the liquid is mounted on a carriage (not illustrated), and ejects the liquid while moving in a scanning manner in the width direction with respect to the target object. In the case of the present embodiment, the “width direction” is the width direction of the conveyance belt 41 intersecting with the rotational direction of the conveyance belt 41 (at a right angle in the present embodiment). By using the line ink jet head 23, the carriage mechanism is not required, and thus hydrogen can be generated at a high speed. By using the serial ink jet head 24, the apparatus can be miniaturized.

In the line ink jet head 23, a supply path for supplying the water-containing liquid to the line ink jet head 23 is connected to the liquid storage case 21 in FIG. 1. The line ink jet head 23 can also provide only one kind of the water-containing liquid. In addition, in the case of providing a plurality of kinds of water-containing liquids, partition walls may be provided in the liquid storage case 21 such that the plurality of kinds of water-containing liquids are not mixed together, and a plurality of liquid supply paths to the line ink jet head 23 may be provided such that the water-containing liquids are not mixed together. Further, if the flow path in the nozzle of the line ink jet head 23 is provided such that the mixing does not occur, the plurality of kinds of water-containing liquids can be provided at arbitrary providing amounts. In addition, in the case of providing the plurality of kinds of water-containing liquids, the plurality of kinds of water-containing liquids can be provided at arbitrary providing amounts by providing a plurality of liquid storage cases 21 and a plurality of line ink jet heads 23.

In addition, the line ink jet head 23 is electrically connected to an electrical controller that transmits power and an ejection control signal. The electrical signal path to the line ink jet head 23 is similar to the electrical signal path to the liquid ejection apparatus 22 illustrated in FIG. 2.

In the serial ink jet head 24, a supply path for supplying the water-containing liquid to the serial ink jet head 24 is connected to the liquid storage case 21 in FIG. 1. The serial ink jet head 24 can also provide only one kind of the water-containing liquid. In addition, in the case of providing a plurality of kinds of water-containing liquids, partition walls may be provided in the liquid storage case 21 such that the plurality of kinds of water-containing liquids are not mixed together, and a plurality of liquid supply paths to the serial ink jet head 24 may be provided such that the water-containing liquids are not mixed together. Further, if the flow path in the nozzle of the serial ink jet head 24 is provided such that the mixing does not occur, the plurality of kinds of water-containing liquids can be provided at arbitrary providing amounts.

In the serial ink jet head 24, a so-called ink tank used in an ink jet printer can be used as the liquid storage case 21, and a plurality of kinds of water-containing liquids can be charged into a plurality of ink tanks for use and providing.

In addition, the serial ink jet head 24 is electrically connected to an electrical controller that transmits power and an ejection control signal. The electrical signal path to the serial ink jet head 24 is similar to the electrical signal path to the liquid ejection apparatus illustrated in FIG. 2.

In the present embodiment, the liquid ejection apparatus 22 preferably ejects the water-containing liquid onto the hydrogen carrier in the form of droplets of a volume equal to or less than 100 pl (picoliter). In addition, the liquid that the liquid ejection apparatus 22 ejects is preferably 20 pl or less. By setting the ejected liquid to 100 pl or less, the contact area between the hydrogen carrier and the water-containing liquid increases, and thus the reaction speed can be increased. In addition, since the water-containing liquid can be provided to a wide area in a very thin layer, generation of bubbles in hydrogen generation can be suppressed.

In the present embodiment, by providing 2 mol equivalent of water to 1 mol equivalent of sodium borohydride by the liquid ejection apparatus 22 described above, the sodium borohydride reacts without excess or deficiency, and thus hydrogen can be collected with the highest efficiency. Therefore, it is preferable that the mol ratio of the amount of water provided by the liquid ejection apparatus 22 to the hydrogen borohydride is about 1:2.

The amount of sodium borohydride can be changed in accordance with the supply amount from the powder application apparatus 12 and the conveyance speed of the conveyance belt 41. The amount of the water-containing liquid is controlled by calculating the amount of sodium borohydride having reached the liquid ejection apparatus 22 portion from the supply amount and the conveyance speed. To be noted, the liquid provided to the sodium borohydride from a dispenser is not limited to water (pure water), and may be an aqueous solution in which a water-soluble acidic substance or water-soluble basic substance is dissolved, an aqueous solution in which a water-soluble organic solvent is dissolved, or a buffer solution that stabilizes the pH near a certain value.

In the case of the present embodiment configured in this manner, since the water-containing liquid is ejected onto the hydrogen carrier in the form of droplets by the liquid ejection apparatus 22, the contact area between the hydrogen carrier and the water-containing liquid increases, thus the reaction speed can be increased, and the reaction between the hydrogen carrier and the water-containing liquid on the conveyance belt 41 can be easily promoted.

By using an ink jet head as the liquid ejection apparatus 22, small droplets of several picoliter can be provided to the hydrogen carrier, and thus the contact area between the hydrogen carrier and the water-containing liquid can be increased and thus the reaction can be caused quickly. In addition, since the water-containing liquid can be selectively provided to locations on the conveyance belt 41 where the hydrogen carrier is present, no excess water is needed, and decrease in the energy density can be suppressed. Further, since the on-off control is easy, it is possible to provide the water only when hydrogen is needed, and thus hydrogen can be obtained quickly.

To be noted, the liquid that the liquid ejection apparatus 22 provides to sodium borohydride is not limited to water (pure water), and may be an aqueous solution in which a water-soluble acidic substance or water-soluble basic substance is dissolved, an aqueous solution in which a water-soluble organic solvent is dissolved, or a buffer solution that stabilizes the pH near a certain value.

In addition, although a case where an ink jet head is used as the liquid ejection apparatus 22 has been described, a different element such as a dispenser may be used.

### Second Embodiment

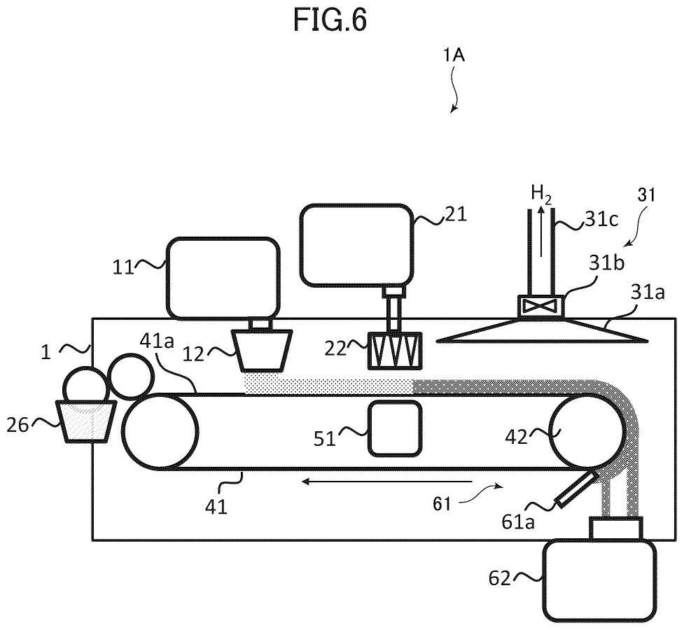

A second embodiment will be described by using FIG. 6. A hydrogen generation apparatus 1A of the present embodiment is different from the first embodiment in that a liquid providing apparatus (second liquid providing apparatus) 26 capable of providing a water-containing liquid to the conveyance belt 41 is disposed on the upstream side of the powder application apparatus 12 in the rotational direction of the conveyance belt 41 in addition to the liquid ejection apparatus (first liquid providing apparatus) 22. The other elements and functions are similar to those of the first embodiment described above, therefore similar elements are denoted by the same reference signs, description and illustration thereof are omitted or simplified, and part different from the first embodiment will be mainly described.

A gravure offset roller is used as the liquid providing apparatus 26. The gravure offset roller is a rubber roller, and is used for offset printing and gravure printing. The liquid providing apparatus 26 is disposed on the upstream side of the powder application apparatus 12 in the rotational direction of the conveyance belt 41 as described above. Particularly, the liquid providing apparatus 26 is disposed so as to provide the water-containing liquid to a part of the outer peripheral surface of the conveyance belt 41 stretched by a driven roller 43. The controller 112 controls the amount of the liquid that the liquid providing apparatus 26 provides to the hydrogen carrier.

As a result of this, the water-containing liquid can be applied on the conveyance belt 41 before the powder is applied. By providing the liquid providing apparatus 26 on the prior stage to the powder application apparatus 12, electrification of the conveyance belt 41 can be prevented. As a result of this, scattering of the hydrogen carrier powder in the apparatus and mixing of the hydrogen carrier powder into the hydrogen collection apparatus 31 can be prevented. To be noted, it is more preferable that the amount of water provided in advance by the gravure offset roller is smaller.

The amount of the water-containing liquid is the sum of the amount provided by the liquid providing apparatus 26 and the amount provided by the liquid ejection apparatus 22. Since a similar reaction to the first embodiment is performed, by providing 2 mol equivalent of water to 1 mol equivalent of sodium borohydride, sodium borohydride reacts without excess or deficiency, and hydrogen can be collected with the highest efficiency. Therefore, it is preferable that the mol ratio of the amount of provided water to sodium borohydride is about 1:2. To be noted, the liquid provided to sodium borohydride from the liquid ejection apparatus 22 and the liquid providing apparatus 26 is not limited to water (pure water), and may be an aqueous solution in which a water-soluble acidic substance or water-soluble basic substance is dissolved, an aqueous solution in which a water-soluble organic solvent is dissolved, or a buffer solution that stabilizes the pH near a certain value.

### Third Embodiment

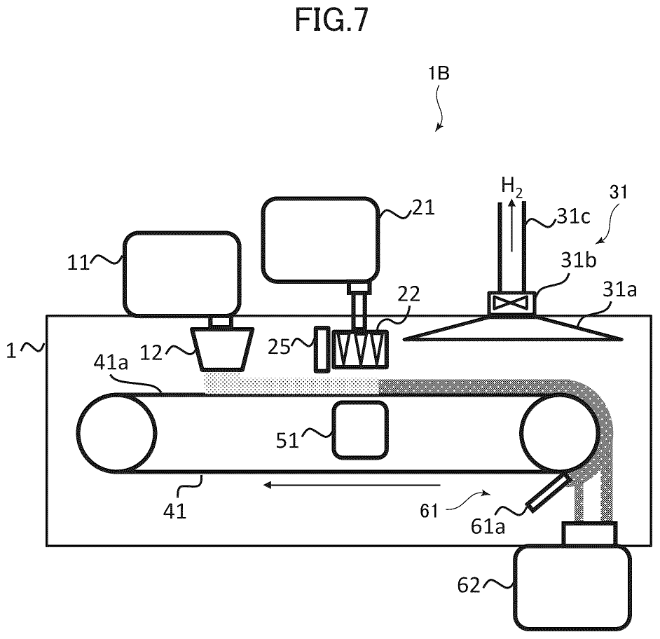

A third embodiment will be described by using FIG. 7. A hydrogen generation apparatus 1B of the present embodiment is different from the first embodiment in that the liquid ejection apparatus 22 is provided with a temperature adjusting apparatus 25. The other elements and functions are similar to those of the first embodiment described above, therefore similar elements are denoted by the same reference signs, description and illustration thereof are omitted or simplified, and part different from the first embodiment will be mainly described.

In the present embodiment, the temperature adjusting apparatus 25 is installed on the outside of the liquid ejection apparatus 22. The temperature adjusting apparatus 25 is a ceramic heater. In addition, a thermometer is provided on the inside of the temperature adjusting apparatus 25. The controller 112 (see FIG. 2) controls the temperature adjusting apparatus 25 on the basis of the detection signal of the thermometer, and adjusts the temperature of the liquid in the liquid ejection apparatus 22 in a predetermined temperature range. The predetermined temperature range is a range higher than 0° and equal to or lower than 80° C.

To be noted, the temperature adjusting apparatus 25 may be a combination of a heater and a cooler, and the temperature of the liquid in the liquid ejection apparatus 22 may be adjusted in the predetermined temperature range by PID control of these. In addition, the temperature adjusting apparatus 25 may be installed on the inside of the liquid ejection apparatus 22. Further, the temperature adjusting apparatus 25 may be disposed on the inside or the outside of the liquid storage case 21. Further, the thermometer for temperature adjustment may be disposed on the inside or the outside of the liquid ejection apparatus 22.

In the present embodiment, since the liquid in the liquid ejection apparatus 22 is adjusted in the predetermined temperature range by the temperature adjusting apparatus 25, the heated water-containing liquid can be provided to the hydrogen carrier. Therefore, the reaction speed between the hydrogen carrier and the water-containing liquid can be increased, and hydrogen can be quickly generated. Therefore, hydrogen can be quickly obtained when hydrogen is needed. In addition, since the reaction between sodium borohydride and water is an exothermic reaction, the conveyance belt 41 in the hydrogen generation apparatus 1 is heated when hydrogen is generated. At this time, a desired hydrogen generation speed can be obtained by controlling the temperature of the water-containing liquid.

### Fourth Embodiment

A fourth embodiment will be described by using FIGS. 1 to 5. In the case of the present embodiment, the liquid ejection apparatus 22 is capable of ejecting two or more kinds of water-containing liquids having different pH. The other elements and functions are similar to those of the first embodiment described above, therefore similar elements are denoted by the same reference signs, description and illustration thereof are omitted or simplified, and part different from the first embodiment will be mainly described.

In the first to third embodiments described above, the reaction is mainly controlled by the providing amount of the liquid provided to the hydrogen carrier. In contrast, in the present embodiment, hydrogen acquisition at a desired reaction speed is made possible by changing the pH of the provided liquid. Therefore, in the present embodiment, it is preferable that the serial ink jet head 24 described with reference to FIG. 5 is used as the liquid ejection apparatus 22. A partition wall is provided in the liquid storage case 21 such that two kinds of water-containing liquids are not mixed together, and water used in the first embodiment and a 30% aqueous solution of citric acid are charged into the liquid storage case 21 so as not to mix together.

In addition, two liquid supply paths are extending from the liquid storage case 21 to the serial ink jet head 24 are provided, and flow paths preventing the mixing are also provided in the nozzle of the serial ink jet head 24. As a result of this, two kinds of liquids can be applied at arbitrary providing amounts.

By providing only the citric acid aqueous solution to the hydrogen carrier, the reaction speed with the hydrogen carrier can be increased, and thus hydrogen can be quickly generated. In addition, after the generation of hydrogen is started, a desired hydrogen generation speed can be obtained by controlling the ratio of providing of the water-containing liquid and the citric acid aqueous solution. The control of arbitrarily providing the two kinds of liquids of water and citric acid aqueous solution is any of providing of only water, providing of water and citric acid aqueous solution, and providing of only citric acid aqueous solution.

Further, in addition to the configuration described above, a 5% aqueous solution of sodium hydroxide may be further prepared and available for providing. By providing only the sodium hydroxide aqueous solution to the hydrogen carrier, the reaction speed with the hydrogen carrier can be reduced, and thus the hydrogen generation can be accelerated or stopped. As a result of this, a desired hydrogen generation speed can be obtained. The control of arbitrarily providing the three kinds of liquids of water, citric acid aqueous solution, and sodium hydroxide aqueous solution is any of providing of only water, providing of water and citric acid aqueous solution, providing of only citric acid aqueous solution, providing of water+sodium hydroxide aqueous solution, and providing of only sodium hydroxide aqueous solution.

Further, in the configuration described above, a 100 mM phosphoric acid buffer liquid having a pH of 6.5 can be used instead of water. In the case of only water, change in the pH of water can occur due to the external environment such as carbon dioxide concentration, but pH can be stabilized by using a buffer liquid, and thus a desired hydrogen generation speed can be obtained.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. A hydrogen generation apparatus comprising:
a first liquid providing apparatus configured to provide a liquid containing at least water to a solid hydrogen carrier; and
a controller configured to control an amount of the liquid that the first liquid providing apparatus provides to the hydrogen carrier,
wherein the first liquid providing apparatus ejects the liquid in a form of droplets of 100 pl or less.

2. The hydrogen generation apparatus according to claim 1, comprising a hydrogen collection apparatus configured to collect hydrogen generated by a reaction between the hydrogen carrier and the liquid.

3. The hydrogen generation apparatus according to claim 1, comprising a conveyance member capable of conveying the hydrogen carrier.

4. The hydrogen generation apparatus according to claim 3, comprising an application apparatus configured to apply the hydrogen carrier on the conveyance member.

5. The hydrogen generation apparatus according to claim 3, comprising a solid product collection apparatus configured to collect a solid product generated by a reaction between the hydrogen carrier and the liquid on the conveyance member.

6. The hydrogen generation apparatus according to claim 1, wherein the hydrogen carrier is metal hydride.

7. The hydrogen generation apparatus according to claim 1, wherein the hydrogen carrier is sodium borohydride.

8. The hydrogen generation apparatus according to claim 1, wherein the first liquid providing apparatus includes a nozzle configured to eject the liquid in a form of droplets.

9. The hydrogen generation apparatus according to claim 1, wherein the first liquid providing apparatus is an ink jet head.

10. The hydrogen generation apparatus according to claim 1, wherein the first liquid providing apparatus ejects the liquid by disposing a heater in a flow path filled with the liquid and generating an air bubble by heating by the heater.

11. The hydrogen generation apparatus according to claim 1, wherein the first liquid providing apparatus ejects the liquid by disposing a piezo element in a flow path filled with the liquid and applying a voltage to the piezo element.

12. The hydrogen generation apparatus according to claim 1, wherein the first liquid providing apparatus ejects the liquid in a form of droplets of 20 pl or less.

13. The hydrogen generation apparatus according to claim 1, further comprising a temperature adjusting apparatus configured to adjust a temperature of the liquid in the first liquid providing apparatus to be higher than 0° C. and equal to or lower than 80° C.

14. The hydrogen generation apparatus according to claim 1, wherein the first liquid providing apparatus is capable of adding two kinds or more of the liquid differing in pH.

15. The hydrogen generation apparatus according to claim 14, wherein one kind of the two kinds or more of the liquid contains an acidic substance.

16. The hydrogen generation apparatus according to claim 14, wherein one kind of the two kinds or more of the liquid contains a basic substance.

17. The hydrogen generation apparatus according to claim 4, further comprising a second liquid providing apparatus capable of providing a liquid containing water onto the conveyance member before applying the hydrogen carrier on the conveyance member by the application apparatus.

18. The hydrogen generation apparatus according to claim 17, wherein the controller is configured to control an amount of the liquid that the second liquid providing apparatus provides to the hydrogen carrier.

19. A hydrogen generation apparatus comprising:
a liquid providing apparatus configured to provide a liquid containing water to a solid hydrogen carrier; and
a hydrogen collection apparatus configured to collect hydrogen generated by a reaction between the hydrogen carrier and the liquid,
wherein the liquid providing apparatus provides the liquid toward the hydrogen carrier in a form of droplets.
